(19) United States
(12) Patent Application Publication
(10) Pub. No.: US 2018/0265742 A1
(43) Pub. Date: Sep. 20, 2018

(54) FLEXIBLE ADHESIVE PLANAR FORMATION FOR STRUCTURAL BONDING

(71) Applicant: TESA SE, Norderstedt (DE)

(72) Inventors: Ute ELLRINGMANN, Hamburg (DE); Uwe SCHÜMANN, Pinneberg (DE); Björn ZEYSING, Hamburg (DE); Marco BALBO-BLOCK, Hamburg (DE)

(73) Assignee: TESA SE, Norderstedt (DE)

(21) Appl. No.: 15/760,770

(22) PCT Filed: Aug. 29, 2016
(86) PCT No.: PCT/EP2016/070306

§ 371 Date: Mar. 16, 2018

(30) Foreign Application Priority Data
Sep. 17, 2015 (DE) 10 2015 217 840.4

(51) Int. Cl. C09J 7/26; C08J 9/36; C09J 5/00

(52) U.S. Cl. CPC C09J 7/26; C08J 9/365; C09J 5/00; C09J 2475/006; C09J 2463/00; C08J 2205/06; C08J 2207/02; C08J 2205/05; C08J 2375/04

(57) ABSTRACT

The present invention relates to a method for producing a flexible adhesive tape for structural bonding, more particularly for clearance compensation, of diverse materials, such as metal, wood, glass and/or plastic, for example.

### TECHNICAL FIELD OF THE INVENTION

The present invention relates to a method for producing a flexible adhesive sheetlike structure for structural bonding, more particularly for clearance compensation, of diverse materials, such as metal, wood, glass and/or plastic, for example, and particularly of bodywork components in the automobile industry.

### GENERAL PRIOR ART

Structural bonding of components, such as in automaking, for example, by means of thermally curing liquid adhesives based on epoxide or on urethane has been known for years. These adhesives are applied via metering machines which are subject to complex control, and in general the adhesives do not possess an initial tack, meaning that the components have to be held in position over the full-curing period in order not to slip.

A disadvantage of such liquid adhesives is that in the thermal full-curing step they pass through a very low-viscosity phase, as a result of which they may propagate or “bleed out” in the bondline and above it as well, thereby causing contamination of the adherend components with the liquid adhesive. In some cases, the fractions of liquid adhesive flowing out of the bondline are in fact so great that it is no longer possible to ensure effective bonding of the components. This problem affects, in particular, bonds with a large surface area and/or those applications where the surfaces of the components to be bonded are uneven, being inclined or in complex 3D shape, for example, with gap differences of up to several mm. Furthermore, the liquid adhesive is activated generally at elevated temperatures, which can be a problem for sensitive components.

DE 10 2011 008 191 A1 describes a heat-activatable, structural, pressure-sensitive adhesive tape having a fabric carrier, which can be used to laminate a plurality of adhesive layers to one another, to give a thickness which is able to compensate tolerances in the application and is able to conform more effectively to dished or curved surfaces. Moreover, the fabric allows the adhesive, if it is liquid during heating, to flow through and to connect with the adhesive on the other side of the fabric. The wicking of liquid constituents of the adhesive through the fabric may mean that the adhesive does not penetrate the fabric uniformly. The wicking, however, ensures that an assembly which is not yet fully cured does not slip. A disadvantage of the pressure-sensitive adhesive system is that the fabric carrier has limited heat resistance, and so it cannot be used together with adhesives which require high temperatures for curing. Accordingly, the pressure-sensitive adhesive system described can be employed, for example, for attaching a mirror mount to the windshield of an automobile, but not for other typical adhesive-bonding applications which take place in the process of manufacturing an automobile and which customarily require temperatures of 180° C. over 30 minutes.

There exists, consequently, a need for a (pressure-sensitive) adhesive system for structural bonding that solves the problems described above and that enables in particular a satisfactory bond strength on the part of the components bonded using the system, without the adhesive running off in the course of curing.

### PROBLEM FOR THE PRESENT INVENTION

The problem addressed by the present invention is therefore that of providing a method for producing an improved, flexible adhesive sheetlike structure that is suitable for structural bonding, especially for compensating gap differences between the components to be bonded. Against this background, the present invention proposes a method as defined in claims 1 to 8, for the production of a flexible adhesive sheetlike structure which circumvents the above-described problems of known liquid adhesives.

Provided more particularly by the method of the invention is a flexible adhesive sheetlike structure which is easy to handle and which, given a suitable choice of adhesive, already exhibits tack, so that there is no slipping during application to the components to be bonded, and so that bonding more precisely than with the liquid adhesives known in the prior art is made possible. Moreover, the flexible adhesive sheetlike structure of the present invention is characterized in that the adhesive remains dimensionally stable in the thermal curing step and, accordingly, does not flow out or “bleed out” from the bondline so that the bonding of the components to be bonded is ensured rapidly and durably and at the same time it is possible to attain high bond strengths. Moreover, with the method of the invention, it is possible to provide flexible adhesive sheetlike structures which are able to compensate gap differences of up to several mm between the components to be bonded (referred to as clearance compensation or else gap filling).

### SUMMARY OF THE INVENTION

The present invention relates to a method for producing a flexible adhesive sheetlike structure, comprising a homogeneous adhesive and a flexible, open-cell foam substrate, wherein the method comprises the following steps:
A. providing the homogeneous adhesive by
   (I) dissolving and/or finely dividing the ingredients, optionally in one or more solvents, optionally with exposure to heat and/or shearing, or
   (II) melting a homogeneous hotmelt adhesive which comprises the ingredients, with exposure to heat;
B. contacting a flexible, open-cell foam substrate with the homogeneous adhesive from step A;
C. (I) evaporating the solvent, if present, and/or
   (II) optionally cooling the foam substrate brought into contact with the adhesive, from step B; and
D. optionally winding up the flexible adhesive sheetlike structure after step C, optionally together with a release liner, to form a roll;

wherein the ingredients comprise at least one (i) polymer, at least one (ii) reactive component, and at least one (iii) activator, and also, optionally, further additives and/or auxiliaries, and wherein the liquid adhesive obtained after step A is absorbed in step B by the open-cell foam substrate.

The flexible adhesive sheetlike structure obtainable by the method of the invention is suitable for structural bonding, more particularly for compensating gap differences between components to be bonded (clearance compensation or gap filling), particularly in the automobile industry.

Additionally provided are a kit comprising at least one flexible adhesive sheetlike structure obtainable by the method of the invention, and a composite body which is joined to the flexible adhesive sheetlike structure produced by the method of the invention, or to the correspondingly cured adhesive sheetlike structure.

### DETAILED DESCRIPTION OF THE INVENTION

In accordance with the invention, the problem described above is solved by the provision of a flexible adhesive sheetlike structure which is obtainable by the method defined in claims 1 to 8.

The present invention is described in detail below.

Method for Producing a Flexible Adhesive Tape

The adhesive sheetlike structure of the invention is produced by the method described below:

In a first step A a homogeneous adhesive is provided; described below are two alternative embodiments of the method of the invention as defined in claim 1:

Step A. (I)

In a first step (step A.(I)), the ingredients are dissolved or finely divided in one or more solvents and mixed to provide a homogeneous, liquid adhesive. This is done optionally with exposure to heat and/or shearing. The mixture is produced using customary stirring apparatus. Alternatively, no solvent is needed, since the ingredients are already completely soluble in one another (optionally with exposure to heat and/or shearing).

Suitable solvents are known in the prior art, and solvents preferably used are those in which at least one of the ingredients has a good solubility. Particularly preferred are butanone or acetone.

The total solids content of the liquid adhesive obtained after step A.(I), if one or more solvents are used, is situated in accordance with the invention in a range from 5 to 90 wt %, preferably in the range from 20 to 80 wt %, and more preferably in the range from 40 to 70 wt %. The total solids content of the adhesive stands here for the total amount of the solids of the ingredients and also of other components present optionally, obtained as a total (in wt %).

As used herein, the term “ingredient” encompasses the polymer (i) used, the reactive component (ii), the activator (iii), and also any further additives and/or auxiliaries, as defined below.

Polymer (i)

The polymer (i) may be one polymer or a mixture of two or more different polymers. The at least one polymer is preferably an elastomer or a thermoplastic.

Examples of polymers are elastomers of the kind used customarily in the field of adhesives, as they are described, for example, in the “Handbook of Pressure Sensitive Adhesive Technology” by Donatas Satas (Satas & Associates, Warwick 1999).

These are, for example, elastomers based on acrylates and/or methacrylates, polyurethanes, natural rubbers, synthetic rubbers such as butyl, (iso)butyl, nitrile or butadiene rubbers, styrene block copolymers having an elastomer block composed of unsaturated or partly or fully hydrogenated polydiene blocks (polybutadiene, polyisoprene, poly(iso)butylene, copolymers of these, and also further elastomer blocks familiar to the skilled person), polyolefins, fluoropolymers and/or silicones.

Where rubber or synthetic rubber or blends produced therefrom are employed as base material for the adhesive, the natural rubber may in principle be selected from all available grades such as, for example, crepe, RSS, ADS, TSR or CV products, according to the required level of purity and viscosity, and the synthetic rubber or synthetic rubbers may be selected from the group of randomly copolymerized styrene-butadiene rubbers (SBR), butadiene rubbers (BR), synthetic polyisoprenes (IR), butyl rubbers (IIR), halogeniated butyl rubbers (XIIR), acrylate rubbers (ACM), ethylene-vinyl acetate copolymers (EVA) or polyurethanes and/or blends thereof.

As the at least one polymer it is also possible to employ any kind of thermoplastics known to the skilled person, as they are described, for example, in the textbooks “Chemie and Physik der synthetischen Polymere” by J. M. G. Cowie (Vieweg, Braunschweig) and “Makromolekulare Chemie” by B. Tieke (VCH Weinheim, 1997), such as poly(ethylene), poly(propylene), poly(vinyl chloride), poly(styrene), poly(oxymethylenes), poly(ethylene oxide), poly(ethylene terephthalate), poly(carbonates), poly(phenylene oxides), poly(urethanes), poly(ureas), acrylonitrile-butadiene-styrene (ABS), poly(amides) (PA), poly(lactate) (PLA), poly(etheretherketone) (PEEK), poly(sulfone) (PSU), and poly(ethersulfone) (PES).

Advantageous polymers for very high bond strengths are poly(amides), polyurethanes, acrylonitrile-butadiene rubbers, and poly(ureas), poly(etheretherketone) (PEEK), poly(sulfone) (PSU), and poly(ethersulfone) (PES).

In one particularly preferred embodiment of the invention, polyurethanes and/or acrylonitrile-butadiene rubbers are used as polymer (i).

The polymer, to give but a few examples, may be linear, branched, star-shaped or grafted in structure, and may be constructed as a homopolymer, a random copolymer, an alternating or a block copolymer. The term “random copolymer” in the sense of this invention includes not only those copolymers in which the comonomers used in the polymerization are incorporated purely randomly, but also those in which there are gradients in the comonomer composition and/or local accumulations of individual varieties of comonomer within the polymer chains. Individual polymer blocks may be constructed as a copolymer block (random or alternating).

The amount of the polymer (i) in accordance with the invention is in the range of about 5-40 wt %, preferably about 15-30 wt %, based on the total solids content of the adhesive. The total solids content of the adhesive here represents the total amount of the solids of the polymer (i) used, the reactive component (ii), the activator (iii), and also further components, present optionally, which is obtained as a sum total (in wt %).

Reactive Component (ii)

As reactive component it is possible in principle to use all reactive constituents that are known to the skilled person in the area of pressure-sensitive adhesives or reactive adhesives and which form crosslinking macromolecules in a molecular enlargement reaction, these reactive constituents being of the type described for example in Gerd Habenicht: Kleben-Grundlagen, Technologien, Anwendungen, 6^{th} edition, Springer, 2009. They are, by way of example, constituents which form epoxides, polyesters, polyethers, polyurethanes, polymers based on phenolic resin, on cresol or on novolac, or polysulfides or acrylic polymers (acrylic or methacrylic). The construction and the chemical nature of the reactive component are not critical, provided it can be produced from precursors which are at least partly miscible with the polymer phase and provided the molecular enlargement reaction can be carried out under conditions, particularly in terms of the temperatures employed, nature of the catalysts used, and the like that do not lead to any substantial impairment and/or decomposition of the polymer phase.

In accordance with the invention, a suitable reactive component is selected from vinyl compounds; acrylic acid, acrylic esters, methacrylic acid and/or methacrylic esters, such as methyl methacrylate; and/or reactive resins, comprising acrylic and methacrylic esters with alkyl groups consisting of 4 to 18 carbon atoms. Specific examples of corresponding compounds, without wishing this recitation to impose any limitation, are n-butyl acrylate, n-butyl methacrylate, n-pentyl acrylate, n-pentyl methacrylate, n-hexyl acrylate, n-hexyl methacrylate, n-heptyl acrylate, n-heptyl methacrylate, n-octyl acrylate, n-octyl methacrylate, n-nonyl acrylate, n-nonyl methacrylate, lauryl acrylate, lauryl methacrylate, hexadecyl acrylate, hexadecyl methacrylate, stearyl acrylate, stearyl methacrylate, behenyl acrylate, behenyl methacrylate, branched isomers thereof such as, for example, 2-ethylhexyl acrylate, 2-ethylhexyl methacrylate, isooctyl acrylate, isooctyl methacrylate, isodecyl acrylate, isodecyl methacrylate, tridecyl acrylate, tridecyl methacrylate, and also cyclic monomers such as, for example, cyclohexyl acrylate, cyclohexyl methacrylate, tetrahydrofurfuryl acrylate, tetrahydrofurfuryl methacrylate, dihydrodicyclopentadienyl acrylate, dihydrodicyclopentadienyl methacrylate, 4-tert-butylcyclohexyl acrylate, 4-tert-butylcyclohexyl methacrylate, norbornyl acrylate, norbornyl methacrylate, isobornylacrylate, and isobornyl methacrylate.

Others which can be employed are acryloylmorpholine, methacryloylmorpholine, trimethylolpropane formal monoacrylate, trimethylolpropane formal monomethacrylate, propoxylated neopentyl methyl ether monoacrylate, propoxylated neopentyl methyl ether monomethacrylate, tripropylene glycol methyl ether monoacrylate, tripropylene glycol methyl ether monomethacrylate, ethoxylated ethyl acrylate such as ethyldiglycol acrylate, ethoxylated ethyl methacrylate, such as ethyldiglycol methacrylate, propoxylated propyl acrylate, and propoxylated propyl methacrylate.

Likewise employable as reactive component (or else reactive resin) are acrylic and methacrylic esters which contain aromatic radicals, such as, for example, phenyl acrylate, benzyl acrylate, phenyl methacrylate, benzyl methacrylate, phenoxyethyl acrylate, phenoxyethyl methacrylate, ethoxylated phenol acrylate, ethoxylated phenol methacrylate, ethoxylated nonylphenol acrylate or ethoxylated nonylphenol methacrylate.

Additionally it is possible to employ aliphatic or aromatic, especially ethoxylated or propoxylated, polyether mono(meth)acrylates, aliphatic or aromatic polyester mono(meth)acrylates, aliphatic or aromatic urethane mono(meth)acrylates or aliphatic or aromatic epoxy mono(meth)acrylates as compounds which carry a (meth)acrylate function.

Preferred for use as compounds which carry at least two (meth)acrylate functions are one or more compounds from the list encompassing difunctional aliphatic (meth)acrylates such as 1,3-propanediol di(meth)acrylate, 1,4-butanediol di(meth)acrylate, 1,6-hexanediol di(meth)acrylate, 1,5-neopentyl di(meth)acrylate, dipropylene glycol di(meth)acrylate, tricyclodecanedimethylol di(meth)acrylate, cyclohexanedimethanol di(meth)acrylate, trifunctional aliphatic (meth)acrylates, such as trimethylolpropane tri(meth)acrylate, tetrafunctional aliphatic (meth) acrylates, such as ditrimethylolpropane tetra(meth)acrylate or ditrimethylolpropane tetra(meth)acrylate, pentafunctional aliphatic (meth)acrylates, such as dipentaerythritol monohydroxypenta(meth)acrylate, hexafunctional aliphatic (meth)acrylates, such as dipentaerythritol hexa(meth)acrylate. Further, if more highly functionalized compounds are used, it is possible to utilize aliphatic or aromatic, especially ethoxylated and propoxylated, polyether (meth)acrylates having in particular two, three, four or six (meth)acrylate functions, such as ethoxylated bisphenol A di(meth)acrylate, polyethylene glycol di(meth)acrylate, propoxylated trimethylolpropane tri(meth)acrylate, propoxylated glycerol tri(meth)acrylate, propoxylated neopentylglycol di(meth)acrylate, ethoxylated trimethylol tri(meth)acrylate, ethoxylated trimethylolpropane di(meth)acrylate, ethoxylated trimethylolpropane tri(meth)acrylate, tetraethylene glycol di(meth)acrylate, ethoxylated neopentyl glycol di(meth)acrylate, propoxylated pentaerythritol tri(meth)acrylate, dipropylene glycol di(meth)acrylate, ethoxylated trimethylolpropane methyl ether di(meth)acrylate, aliphatic or aromatic polyester (meth)acrylates having, in particular, two, three, four or six (meth)acrylats functions, aliphatic or aromatic urethane (meth)acrylates having, in particular, two, three, four or six (meth)acrylate functions, aliphatic or aromatic epoxy(meth)acrylates having, in particular, two, three, four or six (meth)acrylate functions.

Particularly preferred in accordance with the invention is the provision, as reactive component (ii) of the adhesive, of epoxy resins and/or of a mixture of different epoxy resins, such as monomeric or polymeric, aliphatic, cycloaliphatic or aromatic epoxides, for example. These materials generally have an average of at least two epoxide groups per molecule, preferably more than two epoxide groups per molecule. The “average” number of epoxide groups per molecule is defined as the number of epoxide groups in the epoxide-containing material, divided by the total number of epoxide molecules present. The polymeric epoxides comprise linear polymers having terminal epoxide groups (e.g., a diglycidyl ether of a polyoxyalkylene glycol), polymers having scaffold oxirane units (e.g., polybutadiene polyepoxide), and polymers having epoxide side groups (e.g., a glycidyl methacrylate polymer or copolymer). The molecular weight of the epoxide-containing material may vary from 58 to about 100 000 g/mol, or more.

Mixtures of different epoxide-containing materials can also be used in hotmelt compositions of the invention, as elucidated below in step A.(II). In this context, the term “hotmelt” is defined to mean that the adhesive is brought without solvent, by heating, to a processing viscosity. The adhesives of the invention may be used either as hotmelts without solvent, or in solvents.

Useful epoxide-containing materials include those which contain cyclohexene oxide groups, especially epoxycyclohexanecarboxylates, such as, for example, 3,4-epoxycyclohexylmethyl 3,4-epoxycyclohexanecarboxylate, 3,4-epoxy-2-methylcyclohexylmethyl 3,4-epoxy-2-methylcyclohexanecarboxylate, and bis(3,4-epoxy-6-methylcyclohexylmethyl) adipate.

Other epoxide-containing materials which are useful in accordance with the invention are glycidyl ethers of polyhdric phenols, obtained by reaction of a polyhydric phenol with an excess of chlorohydrin, such as epichlorohydrin (e.g., the diglycidyl ether of 2,2-bis(2,3-epoxypropoxyphenol)propane). Other examples of epoxides of this type which may be used in the application of this invention are described in U.S. Pat. No. 3,018,262.

There are a large number of commercially available epoxide-containing materials which can be used in this invention.

They include in particular the following: octadecylene oxide, epichlorohydrin, styrene oxide, vinylcyclohexene oxide, glycidol, glycidyl methacrylate, diglycidyl ethers of bisphenol A (e.g., those available under the tradenames EPON 828, EPON 1004, and EPON 1001F from Shell Chemical Co. and

DER-332 and DER-334 from Dow Chemical Co.), diglycidyl ethers of bisphenol F (e.g., ARALDITE GY281 from Ciba-Geigy), vinylcyclohexene dioxide (e.g., ERL 4206 from Union Carbide Corp.), 3,4-epoxycyclohexylmethyl 3,4-epoxycyclohexene-carboxylate (e.g., ERL-4221 from Union Carbide Corp.), 2-(3,4-epoxycyclohexyl-5,5-spiro-3,4-epoxy)cyclohexane-metadioxane (e.g., ERL-4234 from Union Carbide Corp.), bis(3,4-epoxycyclohexyl) adipate (e.g., ERL-4299 from Union Carbide Corp.), dipentene dioxide (e.g., ERL-4269 from Union Carbide Corp.), epoxidized polybutadiene (e.g., OXIRON 2001 from FMC Corp.), silicone resin-containing epoxide functionality, epoxysilanes (e.g., beta-(3,4-epoxycyclohexyl) ethyltrimethoxysilane and gamma-glycidyloxypropyltrimethoxysilane, available commercially from Union Carbide), flame-retardant epoxy resins (e.g., DER-542, a brominated epoxy resin of bisphenol type, available from Dow Chemical Co.), 1,4-butanediol diglycidyl ethers (e.g., ARALDITE RD-2 from Ciba-Geigy), hydrogenated epoxy resins based on bisphenol A epichlorohydrin (e.g., EPONEX 1510 from Shell Chemical Co.), and polyglycidyl ethers of phenol-formaldehyde novolac (e.g., DEN-431 and DEN-438 from Dow Chemical Co.).

The reactive component and/or the activator, defined below, may likewise be present in blocked form, where the blocked form can be converted into the active form after the mixing of the adhesive, by means of an external influence. Examples that may be given here include blocked isocyanates, alcohols, and amines. The blocking of the reactive functions and the substances used for that purpose, and the use of raw materials having blocked functionalities, are known to the skilled person.

The amount of the reactive component is defined here as the ratio of the fraction of the reactive component to the fraction of the polymer component. In accordance with the invention, 20 to 800 parts, preferably 50 to 600 parts, and more preferably 100 to 400 parts are used per 100 parts of polymer component. The fraction of the reactive component is understood here to be the sum total of all reactive components present in the adhesive. Similarly, the fraction of the polymer component represents the sum total of all polymer components present in the adhesive.

Activator (iii)

As used herein, the term “activator” (or else “initiator” or “curing agent”) stands for a compound which is able to initiate a polymerization reaction or crosslinking of the adhesive, or which is able to participate therein itself as a reaction partner to the reactive component.

At least one activator (iii) is added to the adhesive of the invention. It is possible to use all activators known in the prior art, according to the reactive component (ii) selected.

For reactive monomers based on acrylate, use is made of radical activators, such as peroxides, hydroperoxides, and azo compounds, for example. For reactive resins based on epoxide, use is made of aminic or thiolic activators or else acidic activators, such as aliphatic amines, aromatic amines, modified amines, polyamide resins, acid anhydrides, secondary amines, mercaptans, especially polymercaptans, polysulfides, dicyandiamide, and organic acid hydrazides, for example.

Particular preference in accordance with the invention is given to using aminic activators (iii), especially dicyandiamide, for the above-described epoxide-based reactive components (ii). According to the reactive component selected, the activator is used in stoichiometric amounts, as in the case of an epoxy resin system with aminic activator, for example, or in substoichiometric amounts, as in the case of an acrylate system with radical activator, for example.

Accelerator

As used herein, the term “accelerator” (or else booster) stands for a compound which even in very low concentrations accelerates the progress of the polymerization.

In the present invention, an accelerator can be added to the adhesive. The effect of this accelerator is to reduce the onset temperature for the polymerization or crosslinking reaction of the reactive component, especially of the epoxy resin. This improves handling at the adhesive bonding stage.

Accelerators which can be used include, in particular, modified and unmodified imidazoles, urea derivatives, acid anhydrides, tertiary amines, polyamines, and combinations thereof, such as, for example, urons of the Dyhard® series, which are available from AlzChem AG, CHEMIEPARK TROSTBERG, Postfach 1262, 83303 Trostberg, Germany. Mention may be made here, by way of example, of Accelerator 960-1, Accelerator 2950, Accelerator 3130, DT 3126-2, XB 5730, or DY 070, which are available from Huntsman International LLC.

The amount of the accelerator is determined in relation to the reactive resin fraction and is expressed in phr (parts per hundred resin). In accordance with the invention, the amount is situated in the range from greater than 0 to about 10 phr, preferably about 0.1-3.0 phr. The most preferred amount is about 0.2-1.0 phr, based in each case on the total amount of reactive resins in the thermally curable pressure-sensitive adhesive.

Further Constituents of the Adhesive

The reactive adhesive films of the present invention may optionally comprise further additives and/or auxiliaries which are known in the prior art, such as, for example, rheology modifiers, foaming agents, fillers, plasticizers, crosslinkers, flame retardants, UV stabilizers, antioxidants or adhesion promoters.

Inductively heatable (iv) metals in finely divided form may be added advantageously to the thermally curable pressure-sensitive adhesive, allowing heating to take place via induction.

Step A. (II)

In an alternative embodiment (step A.(II)), a hotmelt adhesive which comprises at least one polymer (i), at least one reactive component (ii), and at least one activator (iii), as defined above and in the claims, may be melted or liquefied with heating to temperatures in the range from 40° C. up to 140° C., according to the adhesive used, in order to obtain a liquid to pastelike adhesive which is suitable for further processing in accordance with step B. “Melting” in the sense of the invention, therefore, is intended to encompass the bringing of the hotmelt adhesive into a flowable form.

A “hotmelt adhesive” here stands for an adhesive which at room temperature (23° C.) is in solid form and which after heating to temperatures in the range from 40° C. up to 140° C. is converted into a flowable form. The hotmelt adhesive rendered flowable via temperature increase is typically contacted in the hot state with the open-cell foam substrate, and cools to form a solid bond with curing.

In accordance with the invention, consequently, a hotmelt pressure-sensitive adhesive is a highly viscous pressure-sensitive adhesive or a highly flowable hotmelt adhesive, both of which undergo drastic alteration in their flow properties with heating.

In accordance with the invention, for example, the following hotmelt adhesives may be used:

| | Example: | | |
|---|---|---|---|
| | K1 | K2 | K3 |
| | parts by | parts by | parts by |
| | weight | weight | weight |
| Breon N41H80 | | | — |
| Desmomelt 530 | 20 | 30 | 40 |
| Epon Resin 828 | — | — | — |
| PolyDis PD3611 | — | — | — |
| PolyDis PD3691 | — | — | — |
| Tactix 556 | 80 | 70 | 60 |
| Dyhard 100S | 4.62 | 4.04 | 3.47 |
| Dyhard UR500 | 0.4 | 0.35 | 0.3 |

The starting materials used are as follows:

| | |
|---|---|
| Breon N41H80 | Nitrile-butadiene rubber with an acrylonitrile |
| | fraction of 41% from Zeon Chemicals (London, |
| | UK). |
| Desmomelt 530 | Largely linear hydroxylpolyurethane. Desmomelt |
| | 530 is a highly crystalline, elastic |
| | polyurethane of very low thermoplasticity from |
| | Bayer MaterialScience. |
| Epon Resin 828 | Difunctional bisphenol A/epichlorohydrin liquid |
| | epoxide having a weight per epoxide of |
| | 185-192 g/eq from Momentive. |
| PolyDis PD3611 | Nitrile rubber-modified epoxy resin based on |
| | bisphenol F diglycidyl ether having an elastomer |
| | content of 40% and a weight per epoxide of |
| | 550 g/eq, from Schill + Seilacher “Struktol”. |
| PolyDis PD3691 | Nitrile rubber-modified epoxy resin based on |
| | bisphenol F diglycidyl ether having an elastomer |
| | content of 5% and a weight per epoxide of |
| | 205 g/eq, from Schill + Seilacher “Struktol”. |
| Tactix 556 | Dicyclopentadiene epoxy novolac resin having a |
| | weight per epoxide of 215-235 g/eq and a |
| | softening point of 53° C., from Huntsman. |
| Dyhard 100S | Latent curing agent from AlzChem for epoxide |
| | systems, consisting of micronized dicyandiamide |
| | in which 98% of the particles are smaller than |
| | 10 μm. |
| Dyhard UR500 | Difunctional, latent uron accelerator for |
| | epoxide systems, in which 98% of the particles |
| | are smaller than 10 μm. |

Step B

Subsequently, in a second step (step B), an open-cell foam substrate as described below is contacted with the mixture of the dissolved or finely divided ingredients according to step A.(I), i.e., with a homogeneous, liquid adhesive, or with a hotmelt adhesive melted with heating according to step A.(II), and comprising the ingredients, so that the open-cell foam substrate is able to absorb the liquid adhesive or melted hotmelt adhesive.

In order to accelerate the absorption of the liquid adhesive according to step A.(I) or of the melted hotmelt adhesive according to step A.(II) into the foam substrate, the foam substrate may be compressed one or more times with a weight, such as 30 mN per mm², for example, for several seconds, such as 5 seconds, for example, before it subsequently expands again and further absorbs adhesive.

In accordance with the invention, the step of the contacting with the liquid adhesive or with the melted hotmelt adhesive, i.e., the drawing-up of the adhesive through the pores of the foam substrate, takes place for about 5 seconds up to 15 minutes, preferably about 5 to 10 minutes, at room temperature (23° C.). Subsequently, the foam substrate is removed from the adhesive and is stored typically on a release liner.

The absorption of the liquid adhesive or of the melted hotmelt adhesive into the pores of the open-cell foam substrate may also be regarded as an imbibition or impregnation. During step B, in accordance with the invention, preferably at least 50% of the pores in the open-cell foam substrate become filled, ideally completely, with the liquid adhesive or the melted hotmelt adhesive.

The operation of impregnating an open-cell foam with adhesive may also be carried out in an efficient roll-to-roll operation. The course of the operation is analogous to the padding operation (or full-bath impregnation operation) established in the textile industry, which is successfully used on an industrial scale for the finishing of fabrics. For the present invention it is possible to use a suitable padding machine. The open-cell foam substrate is unwound at one end of the machine and guided via suitable conveying rollers through a bath filled with the adhesive. The residence time in the bath is controlled by the setting of the machine speed. The foam impregnated with adhesive is subsequently passed through two or more roll pairs which are able to strip off excess adhesive and which, via an adjustable pressure, permit the precise setting of the amount of the adhesive in the foam (i.e., degree of filling of the foam with adhesive).

In accordance with the invention, the degree of filling of the pores in the open-cell foam can be adjusted via the solids content of the liquid adhesive to be imbibed, if a solvent is used, or by the viscosity of the liquid adhesive or of the melted hotmelt adhesive. Via the degree of filling of the pores in the open-cell foam it is possible in turn, in accordance with the invention, to set the shear strength of the resultant bond, i.e., the bond strength achieved. The rule here, fundamentally, is as follows: (i) the higher the solids content, the higher the shear strength or bond strength achieved by the fully cured adhesive sheetlike structure between the adherend substrates in the bonded state. Preferably, in accordance with the invention, as elucidated above, the solids content of the liquid adhesive after step A.(I) is in the range from 5 to 90 wt %, preferably in the range from 20 to 80 wt %, and more preferably in the range from 40 to 70 wt %. (ii) The lower the viscosity, the higher the shear strength or bond strength achieved by the fully cured adhesive sheetlike structure between the adherend substrates in the bonded state. Preferably, in accordance with the invention, as elucidated above, the viscosity of the melted adhesive according to step A.(II) at the temperature used for melting is in the range of 1-1000 Pa*s, preferably in the range of 5-100 Pa*s, more preferably in the range of 10-50 Pa*s.

Moreover, in accordance with the invention, it is possible to use the selected solids content of the liquid adhesive to set the desired fracture mode of the fully cured adhesive sheetlike structure between the adherend substrates in the bonded, fully cured state—that is, whether adhesive or cohesive fracture occurs. “Adhesive fracture” is present when the detachment of the parts bonded to one another via the adhesive sheetlike structure of the invention takes place at the interface, i.e., the adhesive sheetlike structure remains completely on one of the bonded substrates. Conversely, “cohesive fracture” is present when there is no complete detachment of the substrates, bonded to one another via the adhesive sheetlike structure of the invention, at the interface, i.e., residues of the adhesive sheetlike structure of the invention remain on the bonded substrates. Adhesive fracture takes place preferably in the case of a solids content of about 50 wt % or more, e.g., about 50 to 90 wt %, preferably about 55 to 70 wt %, whereas cohesive fracture in accordance with the invention takes place preferably at a solids content of about 45 wt % or less, e.g., about 10 to 45 wt %, preferably 15 to 35 wt %.

Open-Cell Foam Substrate

An “open-cell foam substrate” (or else “open-cell (filter) foam” or “open-cell foam material”) is a substrate having a cellular structure and a low density (or weight per unit volume) that can be reduced significantly in its volume by pressure, i.e., is compressible, but which still has elastic/viscoelastic behavior with a minimum restoring force. “Open-cell” in this context means that the substrate contains cell walls which are open, i.e., that liquids can be absorbed. The “open-cell foam substrate” in the sense of the invention must fundamentally be capable of absorbing liquids (or the liquid adhesive or melted hotmelt adhesive), meaning that mixed-cell foam substrates as well are suitable in principle for the invention. At one end of the spectrum, the open-cell foam substrate consists, in accordance with the invention, only of cell webs. Contrasting with these are closed-cell foam substrates, in which the walls between the individual cells are completely closed; i.e., in principle, no liquids can be absorbed. Mixed-cell foams contain both kinds of cells.

The function of this foam substrate is to form an inert scaffold for the adhesive, so that the adhesive is unable to give rise to the problems identified in the prior art, but is instead absorbed (or imbibed) by the open-cell foam substrate, before or during the contacting, and is subsequently incorporated into said substrate. In this way, greater ease of handling is ensured, and an efflux (or “bleeding out”) of the adhesive is prevented, so that the attainable bonding in the end product is ensured at any time. The foam substrate in step B is flexible or compressible. After the bonding and curing/crosslinking, the foam substrate is no longer flexible, but is instead fixed in the desired form by the adhesive which has cured in the pores of the foam substrate.

“Inert” in this context means that the reactive component (ii) of the adhesive, i.e., reactive monomers and/or reactive resins such as epoxy resins, as defined above, substantially do not react with the foam substrate under suitably selected conditions (e.g., at sufficiently low temperatures).

Foams which can be used as the open-cell foam substrate in the sense of the present invention are all those which are open-cell foams. A version of the foam having a gradient in density may be advantageous in order to provide a gradient likewise to the degree of filling of the adhesive in the foam and so to influence the fracture behavior after curing of the adhesive. In principle, it is also possible for woven fabrics, nonwovens or any other structure to be used in accordance with the invention, provided they have an open-cell structure or a structurally open construction which is able to serve as an inert scaffold for the liquid adhesive or for the melted hotmelt adhesive, as explained above, so that the liquid adhesive or the melted hotmelt adhesive can be absorbed or imbibed into this scaffold in accordance with the invention.

The open-cell foam substrate may be present in any desired form. The open-cell foam substrate is preferably already in the form of a sheet, a tape or a strip of any desired width, or else of a pad of any desired contour, which optionally may be wound to a roll. Alternatively, the open-cell foam substrate may be wound onto a roll during the method (step D) and slit to form a tape of any desired width, strips of any desired width, or pads of any desired contour. The liquid adhesive according to step A.(I) or A.(II) must fundamentally be capable of wetting the foam substrate in step B. The temperature stability of the foam substrate is preferably higher than the crosslinking temperature of the adhesive. Preference is given to using polar foam substrates having a high surface energy, so that the surface energy of the foam substrate is higher than the surface energy of the adhesive.

Suitable open-cell foam substrates for use in the present invention are preferably selected from the following list: polyurethane and/or derivatives thereof, especially elastomeric polyurethane esters and ethers; melamine and/or derivatives thereof; nitrile rubber; polystyrene; and phenolic resins.

One preferred embodiment in accordance with the invention uses a flexible polyurethane foam, more particularly an elastomeric polyurethane ester or ether.

One particularly preferred embodiment in accordance with the invention uses foam substrates of the Inducon® series which are available commercially from Mayser GmbH & Co. KG Polymer Electric, Örlinger Str. 1-3, 89073 Ulm, Germany. Foam substrates of the Inducon® series are cellular polyurethane elastomers which are based on thermally compacted, flexible ester or ether foam.

The thickness of the foam substrate in accordance with the invention is in the range from about 0.1 mm to 5 mm, preferably about 0.2 to 1 mm.

The number of pores in the foam substrate in accordance with the invention is in the range from about 10 to 110 PPI (PPI =pores per inch), preferably about 60 to 80 PPI. The pores are preferably regular and/or defined.

The density (or weight per unit volume) of the foam substrate in accordance with the invention is in the range from about 5 kg/m³ to 1000 kg/m³, preferably 40 kg/m³ to 800 kg/m³, especially preferably 100 kg/m³ to 500 kg/m³. The higher the density of the foam, the lower the degree of filling that can be achieved with the liquid or melted (hotmelt) adhesive after impregnation. Via the density of the foam substrate it is likewise possible in accordance with the invention to control the shear rate and/or bond strength of the adhesive sheetlike structure in the fully cured, bonded state.

Step C

In one preferred embodiment of the invention, the viscosity of the adhesive is increased after the contacting with the foam substrate, but before the use. This may be achieved by (I) evaporating off a solvent, if present, at room temperature (23° C.) or higher temperatures—preferably at the boiling temperature of the solvent used—over a period of several minutes up to several hours, such as overnight, for example; (II) cooling the product obtained from step B to room temperature (23° C.), if a hotmelt adhesive according to step A.(II) has been used or the adhesive according to step A.(I) has been heated; or (III) carrying out preliminary crosslinking (or preliminary curing) of the adhesive by radiation or chemical reaction at elevated temperature. Preliminary crosslinking, for example, can be carried out by electron beam treatment. This improves the technical adhesive properties in the uncured state and prevents the adhesive flowing out of the foam matrix when a pressure is applied, of the kind which occurs when a roll of adhesive tape is wound, for example.

Step D

In a further step (step D), optionally, the flexible adhesive sheetlike structure thus obtained can be wound to form a roll. Alternatively, diecut parts are produced from it in accordance with methods that are customary in the prior art.

For storage, the flexible adhesive sheetlike structures of the invention are preferably lined with a release liner or release paper.

Flexible Adhesive Sheetlike Structure

The flexible adhesive sheetlike structure which is produced in accordance with the method of the invention comprises in the simplest case an open-cell foam substrate and the thermally curable (hotmelt) adhesive, and the structure may be represented according to the method described herein.

An “adhesive sheetlike structure” here is a sheetlike foam substrate as carrier material, impregnated with (hotmelt) adhesive, that is optionally lined on both sides with a release liner and is optionally wound up into an Archimedean roll. Also possible is the printing and diecutting of self-adhesive labels in tape form from the adhesive sheetlike structure, by methods which are known in the prior art.

The adhesive sheetlike structure obtainable by the method of the invention is preferably a flexible adhesive sheet, a flexible adhesive tape, a flexible adhesive strip or a flexible adhesive pad, more particularly of pressure-sensitive adhesive design in each case, as may be set through choice of suitable adhesives. Suitable pressure-sensitive adhesives include adhesives based on acrylate, on polyurethane, on synthetic rubber, on natural rubber, on silicone or on epoxide.

In one preferred embodiment according to the invention, the flexible adhesive sheetlike structure comprises an open-cell flexible polyurethane foam which is impregnated at least partly with a thermally curable adhesive that comprises the following constituents: (i) nitrile-butadiene rubber, (ii) epoxy resin based on bisphenol A diglycidyl ether, (iii) dicyandiamide, and (iv) a 1,1-dialkyl-3-arylurea (uron accelerator).

In an alternative preferred embodiment in accordance with the invention, the flexible adhesive sheetlike structure comprises an open-cell flexible polyurethane foam which is impregnated at least partly with a thermally curable adhesive that comprises the following constituents: (i) an elastic polyurethane, (ii) dicyclopentadiene epoxy novolac resin, (iii) dicyandiamide, and (iv) a 1,1-dialkyl-3-arylurea (uron accelerator).

The flexible adhesive sheetlike structure obtainable by the method of the invention generally possesses a layer thickness in the range of about 0.1 mm-10 mm, preferably about 0.25 mm-5 mm, and more preferably about 1-3 mm. For applications in automobile bodyshell construction, a layer thickness of 0.25 mm-0.5 mm is particularly preferred. For the production of larger layer thicknesses it can be advantageous to laminate a plurality of adhesive sheetlike structures together.

Furthermore, the adhesive sheetlike structure obtainable by the method of the invention is particularly advantageous if the bond strength of the fully cured, pressure-sensitively adhesive sheetlike structure, measured by the dynamic shear test on steel, as described hereinafter, is at least 2 MPa, preferably 5 MPa, more preferably more than 10 MPa. Bond strengths of this kind ensure a very stable and durable join between the materials to be bonded, and are also suitable, for example, for bonds involving exacting demands on the bond strength, as in the automobile industry, for example. Furthermore, through the method of the invention, it is possible to achieve different strengths—adapted to the particular requirements of different applications—with one adhesive, by varying the degree of filling of the foam with adhesive. As a result of this procedure, again with a suitable degree of filling of the foam with adhesive, it is possible to generate a cohesive fracture mode which, for many applications, is a requirement which is nevertheless often unachievable with the adhesive alone.

Furthermore, the adhesive sheetlike structure obtainable by the method of the invention may comprise further films, layers, adhesives, (permanent or temporary) carriers, release papers and/or release lines.

Substrates

Suitable substrates appropriate for adhesive bonding via the adhesive sheetlike structure obtainable by the method of the invention are metals, glass, wood, concrete, stone, ceramic, textile and/or plastics. The substrates to be bonded may be alike or different.

In one preferred embodiment, the adhesive sheetlike structure obtainable by the method of the invention is used for the bonding of metals, glass, and plastics, particularly those having oiled surfaces.

The substrates, moreover, may have undergone coating, printing, vapor deposition, sputtering or other pretreatment, such as pretreatment by flaming, corona, plasma or chemical processes, for example, such as the application of a liquid adhesion promoter/primer. Particularly in the case of application to metals, in the automobile industry, for example, the substrates may also have been coated with an oil.

The substrates to be bonded may take on any desired form which is needed for the use of the resulting composite body.

In the most simple form, the substrates are planar. Furthermore, three-dimensional substrates as well, which are inclined, for example, or have a complex 3D structure, can be bonded with the adhesive sheetlike structure obtainable by the method of the invention. In particular it is possible to compensate gap differences occurring between the substrates (referred to as “clearance compensation”).

Kit

Also provided in accordance with the invention is a kit for providing an adhesive sheetlike structure obtainable by the method of the invention, the kit comprising at least one adhesive sheetlike structure produced by the method of the invention, as described above. A further constituent of the kit might be, for example, a molding to be bonded, an interior trim element for an automobile, or an auxiliary means with which the flexible, pressure-sensitively adhesive sheetlike structure can be applied to a substrate, and the constituents of the kit may be present in a joint pack.

The flexible, pressure-sensitively adhesive sheetlike structure in a kit of the invention is typically used as follows:

The adhesive sheetlike structure is applied to a surface of a substrate to be bonded. This substrate is thereupon contacted with a surface of a second substrate to be bonded, and is left in contact for a pressing time in the range from a few seconds up to several minutes at room temperature (23° C.), and is then heated in the range from a few minutes up to a few hours at elevated temperatures, such as 100 to 200° C., for example, preferably about 160° C., to initiate a polymerization reaction and to cure the adhesive (thermal curing). Alternatively, the polymerization reaction may be initiated, and curing accomplished, via radiation induction, such as with UV light or a light flash, for example. The choice of curing method is dependent on the reactive component selected.

Following the thermal or radiation-induced curing, the adhesive sheetlike structure produced by the method of the invention loses its flexibility and solidifies in the form dictated by the substrates to be bonded; here it is possible to achieve bridging of gap differences; and so even substrates of complex shape which do not fit exactly to one another, being characterized, that is, by an uneven bondline, can be bonded to one another.

Composite Body

Further provided in accordance with the invention is a composite body which is joined by the adhesive sheetlike structure produced by the method of the invention, as defined above, or by the kit of the invention, as defined above, or by the cured adhesive sheetlike structure. A “composite body” in this context is any three-dimensional article which consists of at least two substrates which are cohered or held together via the adhesive sheetlike structure of the invention after curing.

Experimental Section

The examples which follow serve to illustrate the present invention, but are in no way to be understood as a limitation on the scope of protection.

Measurement Methods

Bond Strength (Tensile Shear):

As a parameter of the quality of the bond achieved, the bond strength of an assembly produced with the pressure-sensitive adhesive tape of the invention was determined for the various pressure-sensitive adhesive tapes. For this purpose, the bond strength was determined quantitatively in each case in a dynamic tensile shear test in a method based on DIN-EN 1465 at 23° C. and 50% relative humidity with a test velocity of 10 mm/min (results in N/mm²=MPa). Materials for bonding used were steel materials, which prior to bonding were cleaned with acetone. The figure reported is the mean of thre measurements.

Viscosity Measurement:

One measure of the flowability of the fluid coating material is the dynamic viscosity. The dynamic viscosity can be determined according to DIN 53019. A viscosity of less than 108 Pa.s is referred to as fluid. The viscosity is measured in a cylinder-type rotational viscometer having a standard geometry according to DIN 53019-1, at a measuring temperature of 23° C. and a shear rate of 1 s-1.

### EXAMPLE 1

### Screening of the Foam Substrates

The foam substrates listed in table 1 were used.

TABLE 1
Foam substrates used

| | | | | Elongation | | |
|---|---|---|---|---|---|---|
| | | | Tensile | at | Shore | |
| | Density | Thickness | strength | break | hardness | Cell |
| Foam substrate | kg/m³ | mm | kPa | % | Shore 0 | structure |
| Inducon S 150 w* | 150 | 0.8 | >500 | >190 | | mixed |
| Inducon S 150* | 150 | 1.0 | >1080 | >140 | 28 ± 3 | mixed |
| Inducon S 230* | 230 | 0.6 | >950 | >200 | 22 ± 3 | mixed |
| Inducon S 230* | 230 | 2.0 | >950 | >200 | 22 ± 3 | mixed |
| Inducon S 230* | 230 | 3.0 | >950 | >200 | 22 ± 3 | mixed |
| Inducon S 400* | 400 | 0.4 | >2000 | >150 | 48 ± 3 | mixed |
| Inducon S 430* | 430 | 0.7 | >1500 | >190 | 52 ± 3 | mixed |
| Inducon S PPI 80* | 100 | 3.0 | >900 | >230 | 17 ± 3 | open |
| Inducon S PPI 80* | 150 | 2.0 | >900 | >230 | 17 ± 3 | open |
| Inducon S PPI 80* | 160 | 1.0 | >900 | >230 | 17 ± 3 | open |
| Inducon S PPI 80* | 200 | 2.0 | >900 | >230 | 17 ± 3 | open |
| Inducon T 95** | 95 | 3.0 | >200 | >160 | | mixed |
| Inducon T 150** | 150 | 1.5 | >421 | >145 | | mixed |
| Inducon T LO 250** | 250 | 1.0 | >720 | >180 | | mixed |
| Mayser TG-S 130 | 130 | 1.0 | >600 | >220 | | mixed |
| Bluefoam | | | | | | |

*Polyurethane ester
**Polyurethane ether

In a kneading apparatus, a 25% solution of an acrylnitrile/butadiene copolymer elastomer (e.g., Nipol 1401LG) in butanone was prepared at 23° C. This solution was added as polymer or impact modifier to a liquid epoxy resin prepared from bisphenol A and epichlorohydrin diepoxide (e.g., Epikote 828; eeq=187 g/eq) at 7.5%. With vigorous stirring, a dicyandiamide-based curing agent (e.g., Dyhard 100S) was added. The solids content was adjusted with butanone to 40 wt %. The individual components of the adhesive are listed below:

Formulation 1

| | |
|---|---|
| Nipol 1401LG | 6.5 g |
| Epikote 828 | 87.5 g |
| Dyhard 100S | 6.0 g |
| Butanone | 150 g |

To produce the adhesive tape, the foam substrates set out above were first of all diecut into pieces measuring 25 mm×25 mm and a 4 kg weight roller was rolled over the pieces 10 times. The foam substrates were placed into the adhesive material and compressed 5 times with a 2 kg weight for about 5 s, in order to accelerate the imbibition of the adhesive into the foam substrates. After 10 minutes in the adhesive material, the samples were removed from the adhesive. The samples were weighed. Following complete evaporation of the solvent, as verified by repeated weighing to constant mass, the samples were applied between two ASTM steel plates. The two plates were additionally fixed with adhesive tape.

The samples were pressed at 6 kg for one minute. Thereafter the samples were crosslinked in an oven at 160° C. for 30 minutes. After cooling had taken place, dynamic shear tests, as explained above, were carried out at 50 mm/min.

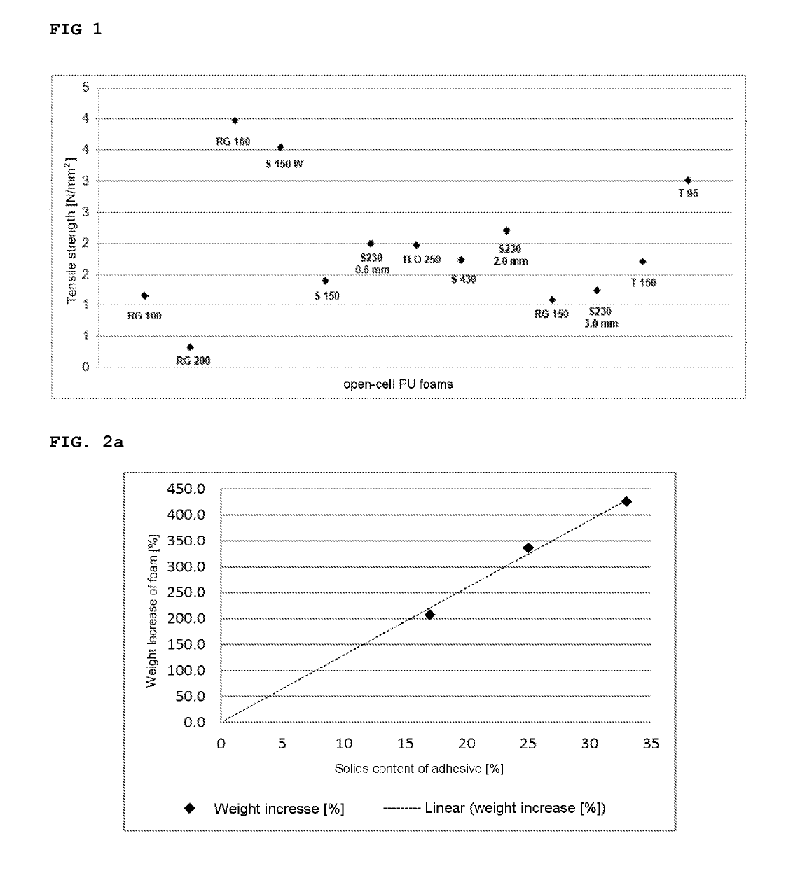

FIG. 1 shows the results of the shear tests on the foam substrates set out above which were impregnated with the adhesive by the method described above. The foam substrates used differ fundamentally in thickness, density, and type (polyether/polyester polyurethane foam), as set out in table 1.

As is evident from FIG. 1, the adhesive tapes produced by the method of the invention can be used to obtain outstanding shear rates and bond strengths after bonding and curing, respectively, when using different types of foam. The desired strengths can be set in principle via the type of foam.

### EXAMPLE 2

### Screening of the Solids Content

The foam substrate used was Inducon S PPI 80 with a density of 160 kg/m³. The thermally curable adhesive according to Example 1 was adjusted in its solids content to (1) 33 wt % solid in butanone/acetone (1:1), (2) 25 wt % solid in butanone/acetone (1:2), and (3) 17 wt % solid in butanone/acetone (1:4). Three foam substrates were impregnated as elucidated above with the three adhesives (1) to (3).

FIG. 2a shows that the degree of filling of the open-cell foam can be adjusted via the solids content of the adhesives, as is apparent from the increase in weight of the impregnated foam. The maximum achievable degree of filling here is dependent on factors including the viscosity of the adhesive.

As is evident from FIG. 2b, the shear strength of the bond obtained correlates with the degree of filling of the foam by the adhesive. The shear strength in turn is a measure of the bond strength achieved. By way of the solids content, consequently, it is possible in principle to adjust the shear strength and/or bond strength of bonded substrates.

### EXAMPLE 3

### Screening the Degree of Filling via the Density of the Foam

The foam substrates recited below were used. The thermally curable adhesive according to Example 1 was used for impregnating the foams, as described above.

Table 2 below illustrates the percentage weight increase of the impregnated foam substrates.

TABLE 2
Percentage weight increase

| | Density | Percentage |
|---|---|---|
| Foam | [kg/m³] | weight increase |
| Inducon S 150 W | 150.0 | 367.8 |
| Inducon S 430 | 430.0 | 150.9 |

The higher the density of the foam, the lower the degree of filling with the adhesive after impregnation. Via the density of the foam, consequently, it is likewise possible to control the shear rate and ultimate strength of the fully cured product.

### EXAMPLE 4

### Cohesive vs. Adhesive Fracture

Similarly to Example 2, the foam substrate used was Inducon S PPI 80 with a density of 160 kg/m³. The thermally curable adhesive with the composition given in table 3 was adjusted in its solid content to (1) 50 wt % solid in butanone/acetone (1:1.3), (2) 35 wt % solid in butanone/acetone (1:3.3), (3) 20 wt % solid in butanone/acetone (1:8.0), and (4) 10 wt % solid in butanone/acetone (1:18.9). Four foam substrates were impregnated as explained above with the four adhesives (1) to (4)

TABLE 3
Composition of the adhesive for Example 4
Formulation 2

| | |
|---|---|
| Desmomelt 530 | 20 g |
| Tactix 556 | 80 g |
| Dyhard 100S | 4.62 g |
| Dyhard UR500 | 0.4 g |
| Butanone | 47.45 g |

For producing the adhesive tape, the four foam substrates were first of all diecut into pieces measuring 15 mm×15 mm. The foam substrates were placed into the adhesive material. After 1 hour in the adhesive material, the samples were removed from the adhesive. The samples were weighed. Following complete evaporation of the solvent overnight on a release liner, as verified by repeated weighing to constant mass, the samples were applied between two ASTM steel plates. The two plates were additionally fixed with adhesive tape and a further ASTM steel plate.

The samples were pressed with a weight of 50 g for one minute. Thereafter the samples were crosslinked in an oven at 180° C. for 1 hour. After cooling had taken place, dynamic shear tests, as explained above, were carried out at 10 mm/min.

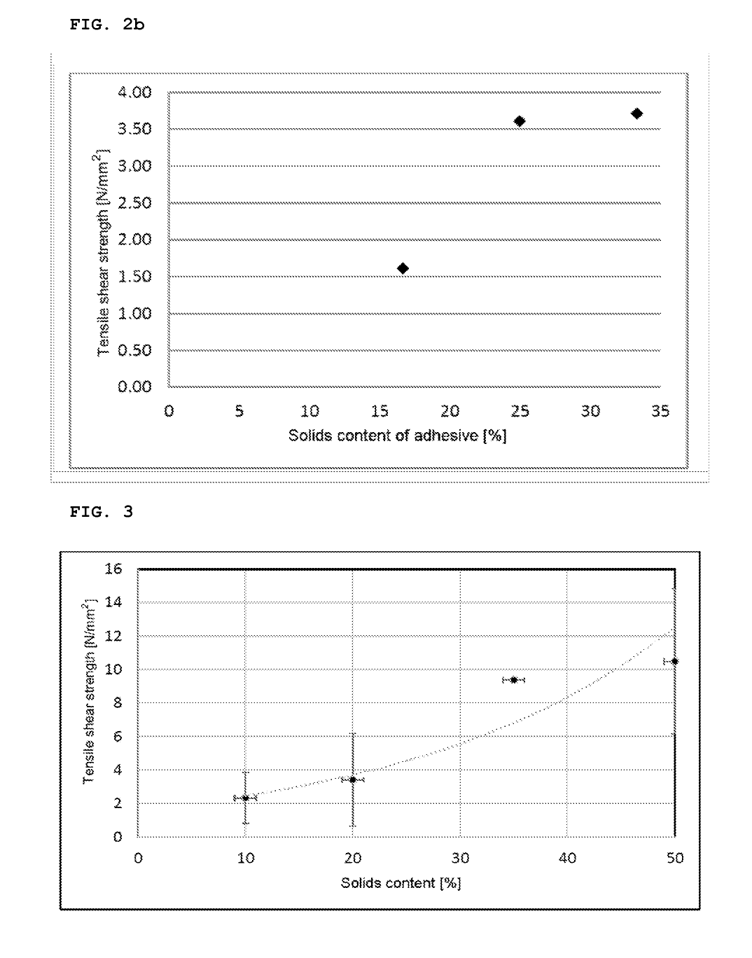

FIG. 3 shows the results of the shear tests on the four foam substrates impregnated with the adhesive by the method described above. As can be seen from FIG. 3, the shear strength of the bond obtained correlates with the solids content of the adhesive. The higher the solids content, the higher the shear strength achieved for the fully cured adhesive tape in the bonded state. High shear strengths imply high bond strengths. Accordingly, high bond strengths in the bonded, fully cured product can be achieved with the adhesive tapes produced by the method of the invention.

The fracture of the four torn-apart samples with the four different solids contents was either adhesive, meaning that detachment occurred at the interface and the adhesive tape remained fully on one plate, or cohesive, meaning that, rather than complete detachment of the adhesive tape, residues of the tape remained on both plates. Adhesive fracture occurred at a solids content of 50 wt %, whereas cohesive fraction occurred at a solids content of 35 wt %, 20 wt % or 10 wt %.

Accordingly, the desired fracture mode as well can be set according to the solids content. Cohesive fracture, for example, is particularly advantageous in automobile construction, since the substrates are therefore exposed in unprotected form to the surroundings (with the possibility, for example, of corrosion); instead, the residues of adhesive tape ensure protection of the substrates.

Furthermore, virtually no adhesive ran out of the respective adhesive tape, since in spite of the lowering in viscosity during the thermal curing, the adhesive was fixed by the open-cell structure of the foam substrate.

1. A method for producing a flexible adhesive sheetlike structure, comprising a homogeneous adhesive and a flexible, open-cell foam substrate, wherein the method comprises the following steps:
A. providing the homogeneous adhesive by
(I) dissolving and/or finely dividing the ingredients, optionally in one or more solvents, optionally with exposure to heat and/or shearing, or
(II) melting a homogeneous hotmelt adhesive which comprises the ingredients, with exposure to heat;
B. contacting a flexible, open-cell foam substrate with the homogeneous adhesive from step A;
C. (I) evaporating the solvent, if present, and/or
(II) optionally cooling the foam substrate brought into contact with the adhesive, from step B; and
D. optionally winding up the flexible adhesive sheetlike structure after step C, optionally together with a release liner, to form a roll;
wherein the ingredients comprise (i) least one polymer, (ii) at least one reactive component, and (iii) at least one activator, and also, optionally, further additives and/or auxiliaries,
wherein the liquid adhesive obtained after step A is absorbed in step B by the open-cell foam substrate.

2. The method as claimed in claim 1, wherein in step B the flexible, open-cell foam substrate is contacted in a padding operation with the homogeneous adhesive after step A and is optionally passed via two or more roll pairs; and/or further, after step B, there is a step for increasing the strength of the adhesive after introduction into the foam substrate.

3. The method as claimed in claim 1, wherein the open-cell foam substrate is a polyurethane and/or a derivative thereof, a melamine and/or a derivative thereof, a nitrile rubber, a polystyrene or a phenolic resin, optionally an elastomeric flexible polyurethane foam.

4. The method as claimed in claim 1, wherein
(4.1) the polymer (i) is selected from an elastomer based on acrylates and/or methacrylates, polyurethanes, natural rubbers, synthetic rubbers; styrene block copolymers having an elastomer block composed of unsaturated or partially or fully hydrogenated polydiene blocks, polyolefins, fluoropolymers and/or silicones; or a thermoplastic; and/or
(4.2) the reactive component (ii) is a reactive resin comprising at least one (meth)acrylic ester having 4 to 18 carbon atoms; or an epoxy resin and/or a mixture of different epoxy resins, optionally an epoxy resin based on bisphenol A, bisphenol S or bisphenol F; an epoxy novolac; an epoxy cresol novolac or an epoxidized nitrile rubber; and/or
(4.3) the activator (iii) is selected from the group consisting of an aliphatic amine, aromatic amine, modified amine, polyamide resin, acid anhydride, secondary amine, mercaptan and/or dicyandiamide.

5. The method as claimed in claim 1, wherein (iv) inductively heatable metals in finely divided form are further present as an ingredient.

6. The method as claimed in claim 1, wherein the open-cell foam substrate possesses a density in the range from about 5 kg/m³ to 1000 kg/m³.

7. The method as claimed in claim 1, wherein the total solids content of the adhesive obtained after step A.(I) is in the range from 5 to 90 wt %, based on the adhesive; and/or wherein the viscosity of the hotmelt adhesive obtained after step A.(II) at the processing temperature is in the range of 1-1000 Pa*s.

8. The method as claimed in claim 1, wherein the weight of the open-cell foam substrate after step C or D has increased by more than 100%, based on the untreated open-cell foam substrate before step B.

9. A flexible adhesive sheetlike structure obtainable by a method as claimed in claim 1.

10. The flexible adhesive sheetlike structure as claimed in claim 9, wherein the flexible adhesive sheetlike structure is a flexible adhesive film, a flexible adhesive tape, a flexible adhesive strip or a flexible adhesive pad.

11. The flexible adhesive sheetlike structure as claimed in claim 9, comprising further films, layers, adhesives, carrier, release paper and/or release liner.

12. A method for adhesively bonding materials made of metal, wood, glass and/or plastic, said method comprising adhesively bonding said materials with the flexible adhesive sheetlike structure as claimed in claim 9.

13. The method as claimed in claim 12, wherein the materials are oiled.

14. A kit comprising at least one flexible adhesive sheetlike structure as claimed in claim 9.

15. A cured adhesive sheetlike structure obtainable by curing the flexible adhesive sheetlike structure as claimed in claim 9.

16. A composite body connected by the flexible adhesive sheetlike structure as claimed in claim 9 or by a cured adhesive sheetlike structure obtainable by curing said flexible adhesive sheetlike structure.
